(19) United States
(12) Patent Application Publication
(10) Pub. No.: US 2011/0223518 A1
(43) Pub. Date: Sep. 15, 2011

(54) PROTON-CONDUCTIVE COMPOSITE ELECTROLYTE, MEMBRANE-ELECTRODE ASSEMBLY USING THE SAME, AND ELECTROCHEMICAL DEVICE USING MEMBRANE-ELECTRODE ASSEMBLY

(75) Inventor: Takuro Hirakimoto, Kanagawa (JP)

(73) Assignee: SONY CORPORATION, Tokyo (JP)

(21) Appl. No.: 13/055,249

(22) PCT Filed: Jul. 9, 2009
(86) PCT No.: PCT/JP2009/062518

§ 371 Date: May 19, 2011

(30) Foreign Application Priority Data
Jul. 25, 2008 (JP) 2008-191650

(51) Int. Cl. H01M 8/10; H01M 8/00

(52) U.S. Cl. 429/482; 429/400; 429/492; 429/493

(57) ABSTRACT

Provided are a proton-conductive composite electrolyte, a membrane-electrode assembly, and a fuel cell in which an improvement of the proton conductivity, and suppression of crossover and insolubilization are satisfied at the same time. The proton-conductive composite electrolyte includes an electrolyte having a proton-dissociative group (—SO₃H) and a compound having a Lewis acid group MXₙ₋₁, wherein the Lewis acid group and the proton-dissociative group are interacted with each other. The compound having the Lewis acid group is a Lewis acid compound MXₙ or a polymer having a Lewis acid group MXₙ₋₁. The electrolyte having a proton-dissociative group is a fluorine-containing electrolyte, an electrolyte composed of a hydrocarbon-based resin, an inorganic resin, a hybrid resin of an organic resin and an inorganic resin, or the like, or a fullerene compound. A membrane-electrode assembly in which catalyst electrodes are closely in contact with both surfaces of the proton-conductive composite electrolyte is preferably used in a fuel cell.

### TECHNICAL FIELD

The present invention relates to a proton-conductive composite electrolyte, a membrane-electrode assembly using the same, and an electrochemical device, such as a fuel cell, using a membrane-electrode assembly.

### BACKGROUND ART

Fuel cells, which are electrochemical devices configured to convert chemical energy to electrical energy, have a high efficiency and do not generate environmental pollutants during the energy conversion. Thus, there have been advances in fuel cells that have been attracting attention as a clean power supply for mobile information devices, households, automobiles, and the like.

Fuel cells are classified into a phosphoric acid-type fuel cell (PAFC), a molten carbonate-type fuel cell (MCFC), a solid oxide-type fuel cell (SOFC), a polymer electrolyte-type fuel cell (PEFC), an alkaline-type fuel cell (AFC), and the like in accordance with the type of electrolyte used. These fuel cells differ from each other in the type of fuel used, the operating temperature, the catalyst, the electrolyte, and the like. Among these, since the PEFC can achieve a low-temperature operation, a high-output density, rapid driving and output response, and the like, the PEFC is believed to be promising not only for small-scale stationary power-generating devices but also power-generating devices used in a transport system such as an automobile.

A membrane-electrode assembly (MEA) which is a main part of the PEFC usually includes a polymer electrolyte membrane obtained by processing a polymer electrolyte into a membrane form, and two electrodes (catalyst electrodes) provided on both surfaces of the polymer electrolyte membrane and respectively functioning as a cathode and an anode.

The polymer electrolyte membrane has a function of a proton conductor, and further has a function of a separation membrane for preventing a direct contact between an oxidizing agent and a reducing agent and a function of electrically insulating the two electrodes. For the polymer electrolyte membrane, conditions such as (1) high proton conductivity, (2) a high electrical insulating property, (3) a low permeability to reactants and reaction products in a fuel cell, (4) satisfactory thermal, chemical, and mechanical stability under the operating conditions of a fuel cell, and (5) a low cost are required.

Heretofore, various types of polymer electrolyte have been developed. It is believed that electrolytes composed of a perfluorosulfonic acid-based resin is excellent in terms of durability and performance.

In the case of a direct methanol fuel cell (DMFC), an aqueous methanol solution is supplied as a fuel to the anode. However, a part of the unreacted aqueous methanol solution permeates through a polymer electrolyte membrane, and this permeated aqueous methanol solution spreads over the electrolyte membrane and reaches a cathode catalyst layer. This phenomenon is called “methanol crossover”. By the methanol crossover, direct oxidation of methanol is caused in the cathode where an electrochemical reduction reaction between hydrogen ions (protons) and oxygen should occur. Consequently, the cathode potential is decreased, which may potentially degrade the performance of the fuel cell. This problem is common to not only fuel cells in which methanol is used but also fuel cells in which other organic fuels are used.

An important task to realize practical application and diffusion of fuel cells is to extend the lifetime of the fuel cells by, for example, suppressing degradation of materials of electrodes, a noble metal catalyst, an electrolyte membrane, and the like in long-term operation; suppressing the influence of water produced by an electrochemical reaction; suppressing a loss of a fuel caused by the permeation of fuel molecules through the electrolyte membrane and subsequent crossover between the electrodes; suppressing the generation of hydrogen peroxide; suppressing the generation of radicals derived from hydrogen peroxide; and suppressing the influence of the radicals. For this purpose, the development of a catalyst material that has a high reaction activity and that is not easily degraded and an electrolyte membrane having a low permeability of fuel molecules and a good proton-conducting property has been desired.

Various methods have been reported regarding the improvement of the proton-conducting property of an electrolyte and the suppression of crossover between electrodes.

First, PTL 1 below titled “Ion-conductive membrane and fuel cell using the same” includes the following description.

The invention of PTL 1 provides an ion-conductive membrane composed of a composite material of an ion-conductive polymer and a nitrogen-containing compound, in which the nitrogen-containing compound has an immobilization site to the ion-conductive polymer and has a tautomeric structure when being protonated. Thus, there is provided an ion-conductive membrane that enables to suppress crossover of methanol while maintaining an ion-conducting property.

In addition, PTL 2 below titled “Ion-conductive membrane, method for producing the same, and electrochemical device” includes the following description.

An object of the invention of PTL 2 is to provide an ion conductor that is insoluble in water and fuels and that can perform stable conduction of ions such as protons, a method for producing the same, and an electrochemical device.

The invention of PTL 2 relates to an ion conductor including a derivative in which an ion-dissociative group is bonded to a carbon substance composed of at least one selected from the group consisting of a fullerene molecule, a cluster containing carbon as a main component, and a structure of a linear or cylindrical carbon; and a polymer of a substance having a basic group.

In addition, PTL 3 below titled “Electrode, composition for electrode, fuel cell using the same, and method for producing electrode” includes the following description.

The electrode according to the invention of PTL 3 is characterized by containing catalyst particles in which catalytic metal particles composed of platinum or an alloy thereof are carried on the surface of a catalyst carrier containing SiO₂ as a main component; electrically conductive particles; and a proton-conductive substance. PTL 3 describes that the catalyst carrier is preferably SiO₂ alone, or a compound oxide that contains 50% by weight or more of a SiO₂ component and that exhibits Lewis acidity.

In addition, PTL 4 below titled “Proton conductor, catalyst electrode, assembly of catalyst electrode and proton conductor, fuel cell, and method for producing proton conductor” includes the following description.

According to an embodiment of the invention of PTL 4, there is provided a proton conductor including an organic proton-conductive polymer; and an inorganic proton conductive material obtained by condensation of an inorganic solid acid, and total 450 to 20,000 parts by mole of a Lewis acidic metal alkoxide and a silicon oxide precursor relative to 100 parts by mole of the inorganic solid acid, in which molecular chains of the organic proton-conductive polymer and molecular chains of the inorganic proton conductive material intrude each other to form a network structure.

By forming the network structure by the mutual intrusion of molecular chains of the organic proton-conductive polymer and molecular chains of the inorganic proton conductive material, swelling with water, methanol, or the like can be suppressed to realize a high dimensional stability, and in addition, a proton conductor having flexibility can be obtained.

In addition, PTL 5 below titled “Electrode material for fuel cell and fuel cell” includes the following description.

In an electrode material for a fuel cell according to the invention of PTL 5, an electrode for a fuel cell is provided on a front surface and/or a back surface of an electrolyte membrane, and the electrode material contains catalyst particles formed by including noble metal particles containing Pt in a porous inorganic material, and a proton-conductive substance. According to this electrode material for a fuel cell, since the noble metal particles are included in the porous inorganic material, elution of Pt in the electrolyte membrane is prevented, and it is possible to suppress a decrease in the performance of the fuel cell caused by the elution of Pt in the electrolyte membrane.

Note that, in the electrode material for a fuel cell according to the invention of PTL 5, materials containing, as a main component, any of SiO₂, ZrO₂, and TiO₂ can be exemplified as the porous inorganic material. Furthermore, the porous inorganic material preferably has a proton-conducting property so as to function as an electrode for a fuel cell. In such a case, the proton-conducting property can be provided to the porous inorganic material by using a material that exhibits Lewis acidity (electron-pair acceptor) as the porous inorganic material.

In addition, PTL 6 below titled “Proton-conductive substance” includes the following description.

An object of the invention of PTL 6 is to provide an electrolyte material having high proton conductivity and a simple method for producing the electrolyte material. In order to achieve high proton conductivity, in the invention of PTL 6, a borosiloxane backbone is focused as a structure that accelerates a dissociation property of sulfonic acid, and the preparation of a borosiloxane polymer by a hydrolysis condensation method, which is an easy production method, and a method for sulfonating the polymer have been studied. As a result, an organic/inorganic hybrid-type proton conductor having high proton conductivity is obtained.

In the reaction mechanism 1 of the method for producing a proton-conductive substance of the invention of PTL 6, an alkoxysilane derivative having a thiol group and a boric acid ester are subjected to a hydrolysis reaction to produce a polymer, and by oxidizing the thiol group, a borosiloxane polymer having a sulfonic acid group is produced. Furthermore, in the reaction mechanism 2, an alkoxysilane derivative having a hydrocarbon group and a boric acid ester are subjected to a hydrolysis reaction to produce a polymer, and by sulfonating the hydrocarbon group, a borosiloxane polymer having a sulfonic acid group is produced. That is, the proton-conductive substance of the invention of PTL 6 can be produced by a hydrolysis condensation reaction between an alkoxysilane derivative and a boric acid ester, followed by sulfonation. However, higher proton conductivity may be achieved by adopting appropriate reaction conditions.

According to the proton-conductive substance of the invention of PTL 6, dissociation of a sulfonic acid group is accelerated by the introduction of Lewis acidic boron, and thus the proton-conductive substance has high proton conductivity. By further doping phosphoric acid, proton conductivity at high temperatures (about 100° C. to about 180° C., in particular about 100° C. to about 150° C.) can be increased.

In addition, PTL 7 below titled “Polymer solid electrolyte” includes the following description.

The invention of PTL 7 relates to a polymer solid electrolyte for a lithium secondary ion battery characterized in that a Lewis acid compound (such as boron trifluoride (BF₃) or a boroxine compound, or the like) is added to a composite material of a polyanion-type lithium salt and an ether-based polymer material, more preferably, the polymer solid electrolyte for a lithium secondary ion battery characterized in that the Lewis acid compound is BF₃. It is believed that BF₃ has a strong interaction with a carboxylate anion, and has an effect of improving ion-conducting property.

Furthermore, PTL 8 below titled “Ion-conductive composition and method for producing the same” includes the following description.

An ion-conductive composition provided by the invention of PTL 8 contains a lithium salt represented by a general formula LiM(OY)ₙX₄₋ₙ (wherein n may be 1 to 3, M may be an element belonging to group XIII of the periodic table, Y may be an oligoether group, and X may be an electron-withdrawing group). This composition further contains an additive that can be coordinated to oxygen (i.e., that can be coordinately bonded to oxygen). For example, the composition contains an additive that can be coordinated to at least one oxygen atom adjacent to M in the lithium salt (i.e., that is directly bonded to M) in the lithium salt. In a typical embodiment of the composition disclosed here, at least a part of the additive in the composition is coordinated to oxygen (preferably, mainly oxygen adjacent to M) contained in an anion of the lithium salt. In other words, in the composition, the additive and the lithium salt (more specifically, an anion constituting the lithium salt) form a coordination compound. Such a composition can have a higher degree of dissociation of the lithium salt than that of, for example, a composition that does not contain the above-mentioned additive. With this configuration, the composition can be a composition that exhibits better characteristics (such as ion conductivity).

In a preferred embodiment of the composition disclosed here, the additive is a strong Lewis acid. Here, the phrase the additive is “a strong Lewis acid” means that, in the composition, the additive is bonded to oxygen more preferentially than to lithium ions, or bonding between lithium ions and the additive occurs in an equilibrium manner. In either case, the interaction between lithium ions and oxygen is weakened by incorporating the additive. Accordingly, the composition containing the additive can be a composition in which the degree of dissociation of a lithium salt is more efficiently increased. Examples of the preferable additive in the invention of PTL 8 include boron halides such as boron trifluoride (BF₃).

Furthermore, PTL 9 below titled “Electrolyte membrane” includes the following description.

An object of the invention of PTL 9 is to provide an electrolyte membrane, in particular, a hydrocarbon-based electrolyte membrane for a solid polymer-type fuel cell, in which the proton-conducting property is improved, and a method for producing the electrolyte membrane. Another object thereof is to provide an electrolyte membrane, in particular, a hydrocarbon-based electrolyte membrane for a solid polymer-type fuel cell, in which a proton-conducting property is improved and degradation of an electrolyte can be suppressed or prevented, and a method for producing the electrolyte membrane. These objects are achieved by an electrolyte membrane obtained by dispersing 1% to 50% by mass of an additive to an electrolyte.

According to the invention of PTL 9, because of the presence of a specific amount of the additive in the electrolyte membrane, the proton-conducting property of the electrolyte membrane can be significantly improved even under the condition of a relatively high humidity. Therefore, even when a hydrocarbon-based electrolyte membrane is used as an electrolyte membrane for a fuel cell, in particular, for a hydrogen-oxygen type fuel cell, a sufficient proton-conducting property can be achieved.

The additive according to the invention of PTL 9 is preferably a fullerene derivative, a metal oxide, or the like. For example, in the case where a fullerenol is used as the additive, since the fullerenol has an effect of improving the proton-conducting property, it is possible to obtain an electrolyte membrane that can achieve a significantly high proton-conducting property, as compared with existing electrolyte membranes, even under the condition of a relatively high humidity (for example, a relative humidity of 60% or more). Therefore, the additive may be useful in a hydrocarbon-based electrolyte membrane, which heretofore has a problem of a low proton-conducting property.

The additive according to the invention of PTL 9 is preferably a fullerene derivative, a metal oxide, or the like as described above. The fullerene derivative is preferably a fullerenol, and the metal oxide is preferably an alkoxysilane or a titanium alkoxide.

In addition, PTL 10 below titled “Fullerene-based electrolyte for fuel cell” includes the following description.

Proton-conductive fullerene substances are added to a polymer material by doping, mechanical mixing, or forming a covalent bond by a chemical reaction. A proton conductor thus prepared can be used as a polymer electrolyte membrane of a fuel cell that operates in a wide range of relative humidity and a wide range of temperature of the boiling point of water or higher. Examples of the preferable proton-conductive fullerene substance include polyhydroxylated fullerene, polysulfonated fullerene, and polyhydroxylated polysulfonated fullerene.

Furthermore, NPL 1 below describes preparation of a borosiloxane solid electrolyte obtained by, in a product obtained by hydrolysis polycondensation of (3-mercaptopropyl)methoxysilane (HS(CH₂)₃Si(OCH)₃), triisopropyl borate (B(OCH(CH₃)₂)₃), and (n-hexyl)trimethoxysilane (CH₃(CH₂)₅Si(OCH)₃), oxidizing a thiol group (—SH) to convert to a sulfonic acid group (—SO₃H), and a composite film composed of this borosiloxane solid electrolyte and Nafion (registered trademark).

Furthermore, NPL 2 below describes preparation of a borosiloxane solid electrolyte obtained by, in a product obtained by hydrolysis polycondensation of (3-mercaptopropyl)methoxysilane (HS(CH₂)₃Si(OCH)₃), triisopropyl borate (B(OCH(CH₃)₂)₃), and (n-hexyl)trimethoxysilane (CH₃(CH₂)₅Si(OCH)₃), oxidizing a thiol group (—SH) to convert to a sulfonic acid group (—SO₃H), and a composite film composed of this borosiloxane solid electrolyte and partially sulfonated poly(ether-sulfone) (SPES).

Note that NPL 3 below describes a method for introducing Lewis acidic boron into a side chain of an organic polymer.

Furthermore, PTL 11 below titled “Polymer-carried Lewis acid catalyst” includes the following description.

First, there is provided a polymer-carried Lewis acid group-containing catalyst characterized in that a Lewis acid group represented by a general formula MXₙ (wherein M represents a polyvalent element, X represents an anionic group, and n represents an integer corresponding to the valence of M) is bonded and carried on a polymer film with an SO₃ or SO₄ group therebetween.

Secondly, there is provided the Lewis acid group-containing catalyst characterized in that a Lewis acid bonding group represented by a general formula —R₀—MXₙ (wherein M represents a polyvalent metal element, X represents an anionic group, n represents an integer corresponding to the valence of M, and R₀ represents an SO₃ or SO₄ group) is bonded and carried on a polymer chain with a spacer molecular chain therebetween.

Furthermore, PTL 12 below titled “Hydrophobic polymer-immobilized Lewis acid catalyst” includes the following description.

(1) There is provided a hydrophobic polymer-immobilized Lewis acid group-containing catalyst characterized in that a metal Lewis acid group is bonded and carried to an aromatic ring of a hydrophobic polymer mainly composed of an aromatic polymer with an SO₃ group therebetween at a controlled carrying ratio. (2) There is provided the hydrophobic polymer-immobilized Lewis acid group-containing catalyst according to (1), characterized in that the Lewis acid group is a rare earth metal salt. (3) There is provided the hydrophobic polymer-immobilized Lewis acid group-containing catalyst according to (2), characterized in that the Lewis acid group is a rare earth metal triflate.

### Citation List

### Patent Literature

PTL 1: Japanese Unexamined Patent Application Publication No. 2002-105220 (paragraphs 0008 and 0054)

PTL 2: Japanese Unexamined Patent Application Publication No. 2005-322555 (paragraphs 0008 to 0009)

PTL 3: Japanese Unexamined Patent Application Publication No. 2002-2460033 (paragraphs 0010 to 0011 and 0028 to 0029)

PTL 4: Japanese Unexamined Patent Application Publication No. 2005-25943 (paragraphs 0037 and 0046)

PTL 5: Japanese Unexamined Patent Application Publication No. 2007-5292 (paragraphs 0007 to 0008)

PTL 6: Japanese Unexamined Patent Application Publication No. 2002-184427 (paragraphs 0004, 0009, and 0022, and FIGS. 1 and 2)

PTL 7: Japanese Unexamined Patent Application Publication No. 2006-318674 (paragraphs 0011 to 0013)

PTL 8: Japanese Unexamined Patent Application Publication No. 2007-115527 (paragraphs 0004 to 0005)

PTL 9: Japanese Unexamined Patent Application Publication No. 2007-265959 (paragraphs 0014 to 0015, 0023, 0028 to 0029, and 0033 to 0034)

PTL 10: Japanese Unexamined Patent Application Publication (Translation of PCT Application) No. 2007-503707 (paragraphs 0008 to 0013)

PTL 11: Japanese Unexamined Patent Application Publication No. 2001-137710 (paragraphs 0008 to 0009)

PTL 12: Japanese Unexamined Patent Application Publication No. 2005-254115 (paragraph 0009)

### Non Patent Literature

NPL 1: H. Suzuki et al., “Proton conducting borosiloxane solid electrolytes and their composites with Nafion”, Fuel Cells, 2002, 2, No. 1, 46-51 (2 Experimental)

NPL 2: T. Fujinami et al., “Proton conducting borosiloxane-poly(ether-sulfone) composite electrolyte”, Electrochimica Acta 50 (2004) 627-631 (2 Experimental and 3 Results and discussion)

NPL 3: Y. Qin et al., “Well-defined Boron-Containing Polymeric Lewis Acids”, J. Am. Chem. Soc., Vol. 124, No. 43, 2002, 12672-12673 (Scheme 1)

### SUMMARY OF INVENTION

### Technical Problem

Electrolyte membranes used in PEFCs or the like have a wide variety of performances that should be satisfied. That is, a high proton-conducting property, a sufficient performance that blocks permeation (cross leak or crossover) of a fuel or oxygen, excellent mechanical strength and heat resistance, and excellent water resistance and chemical stability, and the like are required.

However, among proton conductor materials for a solid polymer electrolyte-type fuel cell that have been used to date, there is no single material that can be formed into a membrane capable of meeting all these requirements by itself, which has been a significant impediment in the development and wide use of fuel cells. One of proton conductors that are widely used in PEFCs and the like is Nafion (trade name; a perfluorosulfonic acid resin manufactured by DuPont). This is a perfluorinated sulfonic acid-based polymer resin, contains no unsaturated bonds and has a perfluorinated structure, and is thermally and chemically stable. However, in a dry atmosphere or at high temperatures, Nafion has a problem that water that is occluded inside the resin and that is necessary for exhibiting the proton-conducting property is lost, and the proton conductivity tends to decrease. Furthermore, there is a problem that Nafion does not have a sufficient performance for blocking permeation (cross leak or crossover) of a fuel.

In the case where the fuel is hydrogen, in order to prevent hydrogen gas supplied to a fuel electrode from permeating into an oxygen electrode side, it is necessary to increase the thickness of the membrane. As a result, the membrane resistance increases, thereby causing a problem of decreasing the output of the cell.

In a perfluorosulfonic acid-based resin, a sulfonic acid group and water adsorbed around the sulfonic acid group form a cluster structure, and protons move using the water in the cluster as a channel, thereby exhibiting a proton-conducting property. Accordingly, in order that this resin exhibits a high proton-conducting property, it is necessary to retain a sufficient amount of water inside. However, in such a case, when the fuel is methanol, the methanol, which has a high hydrophilicity, is dissolved in the water inside the resin and easily permeates through the membrane.

Fullerene derivatives in which a proton-dissociative group, e.g., a sulfonic acid group, is introduced into a carbonaceous material such as fullerene are promising materials in the respect of having a proton-conducting capability even in a non-humidified state. Thus, the application of such fullerene derivatives to fuel cells has been studied. However, many fullerene derivatives in which a proton-dissociative group is introduced are water-soluble and have a property of being easily hydrolyzed.

It should be noted that, here, the “proton-dissociative group” means a functional group from which a hydrogen atom is ionized as a proton (H⁺) and can be removed, and is represented by a formula —XH wherein X is any atom or atomic group having a divalent bonding hand (hereinafter the same).

It is known that, in a fullerene derivative, the larger the number of proton-dissociative groups that are introduced into one fullerene molecule, the higher the proton-conducting property. However, the proton-dissociative groups are hydrophilic, and thus the larger the number of introduced proton-dissociative groups, the more easily the fullerene derivative is hydrated, and the higher the solubility of the fullerene derivative. When a water-soluble fullerene derivative is used as an electrolyte of a fuel cell, the electrolyte is eluted into water produced by an electrode reaction in the fuel cell, and is lost by the elution. Therefore, in order to use a fullerene derivative by itself as an electrolyte, it is necessary to use a fullerene derivative that has a high proton-conducting property and that is hardly soluble in water. Thus, there are so many restrictions in the material design and the material selection.

It is difficult to satisfy an improvement of the proton-conducting property of the electrolyte, and a suppression of methanol permeability of the electrolyte and insolubilization of the electrolyte at the same time. The suppression of swelling of the electrolyte and insolubilization of the electrolyte can be realized by using an interaction between a proton and a basic compound. However, the number of protons that contribute to the conduction decreases, resulting in a decrease in the proton-conducting property.

In order to develop a polymer electrolyte membrane in which the methanol crossover is suppressed and which has good ion conductivity, various studies on electrolytes have been conducted. However, a polymer electrolyte membrane having a sufficient performance has not yet been obtained.

The present invention has been made in order to solve the above problems, and it is an object of the present invention to provide a proton-conductive composite electrolyte in which an improvement of the proton conductivity, and a suppression of crossover of methanol or the like and insolubilization can be realized in combination, a membrane-electrode assembly using the same, and an electrochemical device, such as a fuel cell, using a membrane-electrode assembly.

### SOLUTION OF PROBLEM

Specifically, the present invention relates to a proton-conductive composite electrolyte including an electrolyte having a proton-dissociative group (for example, SO₃H in an embodiment described below), and a compound having a Lewis acid group (for example, MR₂ in an embodiment described below), wherein an electron-accepting atom constituting the Lewis acid group and an electron-donating atom constituting the proton-dissociative group are bonded to each other. Herein, the term “Lewis acid group” means a functional group functioning as a Lewis acid (hereinafter the same).

Also, the present invention relates to a membrane-electrode assembly including an electrolyte membrane composed of the above proton-conductive composite electrolyte, and catalyst electrodes in which a catalyst metal is carried on an electrically conductive carrier, wherein the catalyst electrodes are disposed on both sides of the electrolyte membrane.

Also, the present invention relates to an electrochemical device including the above membrane-electrode assembly, wherein the electrochemical device is configured so that a proton generated in one of the pair of catalyst electrodes disposed on both sides of the electrolyte membrane is moved to the other catalyst electrode by the electrolyte membrane.

### ADVANTAGEOUS EFFECTS OF INVENTION

According to the present invention, the proton-conductive composite electrolyte includes an electron-accepting atom constituting the Lewis acid group and an electron-donating atom constituting the proton-dissociative group, the atoms being bonded to each other by an interaction. Therefore, it is possible to provide a proton-conductive composite electrolyte in which proton dissociation is accelerated to improve the proton-conducting property, whose swelling with water is suppressed and which can be insoluble in water, and which can suppress crossover.

In addition, according to the present invention, the membrane-electrode assembly includes an electrolyte membrane composed of the above-described proton-conductive composite electrolyte and catalyst electrodes in which a catalyst metal is carried on an electrically conductive carrier, wherein the catalyst electrodes are disposed on both sides of the electrolyte membrane. Accordingly, it is possible to provide a membrane-electrode assembly suitable for a fuel cell, in which proton dissociation is accelerated to improve the proton-conducting property, and swelling of the electrolyte with water is suppressed and the electrolyte is insoluble in water, and which can decrease the permeability of methanol or the like to suppress methanol crossover or the like.

In addition, according to the present invention, the electrochemical device such as a fuel cell includes the above-described membrane-electrode assembly. Therefore, it is possible to provide an electrochemical device such as a fuel cell in which proton dissociation is accelerated to improve the proton-conducting property, and swelling of the electrolyte with water is suppressed and the electrolyte is insoluble in water, and which can decrease the permeability of methanol or the like to suppress methanol crossover or the like.

### BRIEF DESCRIPTION OF DRAWINGS

FIG. 1 includes drawings for explaining a proton-conductive composite electrolyte according to an embodiment of the present invention.

FIG. 2 includes drawings for explaining examples of a Lewis acid and examples of a Lewis acid group in an embodiment of the present invention.

FIG. 3 is a cross-sectional view showing an example of a direct-type methanol fuel cell to which a polymer electrolyte having a Lewis acid group is applied, according to an embodiment of the present invention.

FIG. 4 is a cross-sectional view showing an example of a polymer electrolyte-type fuel cell to which a polymer electrolyte having a Lewis acid group is applied, according to an embodiment of the present invention.

### DESCRIPTION OF EMBODIMENTS

In the proton-conductive composite electrolyte of the present invention, the compound is preferably, in particular, a polymer having a plurality of the Lewis acid groups in the side chains thereof. According to this configuration, it is possible to provide a proton-conductive composite electrolyte in which proton dissociation is accelerated to improve the proton-conducting property, whose swelling with water is suppressed, and which can be insoluble in water.

In addition, the proton-dissociative group is preferably at least one selected from the group consisting of a sulfonic acid group (—SO₃H), a phosphonic group (—PO(OH)₂), a bis-sulfonimide group (—SO₂NHSO₂—), a sulfonamide group (—SO₂NH₂), a carboxyl group (—COOH), a diphosphonomethano group (═C(PO(OH)₂)₂), and a disulfonomethano group (═C(SO₃H)₂). According to this configuration, proton dissociation is accelerated to improve the proton-conducting property.

In addition, the electron-accepting atom constituting the Lewis acid group is preferably boron (B) or aluminum (Al). According to this configuration, proton dissociation is accelerated to improve the proton-conducting property.

In addition, the electrolyte is preferably a fullerene compound having the above-mentioned proton-dissociative group such as a sulfonic acid group (—SO₃H). According to this configuration, it is possible to provide a proton-conductive composite electrolyte in which proton dissociation is accelerated to improve the proton-conducting property, and whose swelling with water is suppressed, and which can be insoluble in water. In addition to such a fullerene compound, at least one selected from the group consisting of a polymer having, in the side chains thereof, a plurality of molecules of a fullerene compound having the proton-dissociative group, a polymer in which a plurality of molecules of a fullerene compound having the proton-dissociative group are linked to each other, and a polymer having a plurality of the proton-dissociative groups in the side chains thereof may also be used.

In the membrane-electrode assembly of the present invention, the catalyst electrodes preferably contain the above-described proton-conductive composite electrolyte. According to this configuration, proton conduction can be performed smoothly, and catalyst electrodes having a stable structure can be realized.

Embodiments of the present invention will now be described in detail with reference to the drawings.

In the description below, MXₙ₋₁ obtained by removing one X from a Lewis acid represented by a general formula MXₙ (n≧3) (wherein M represents a polyvalent element, and X represents an anionic group) is referred to as “Lewis acid group”. Note that the anionic group X may also be represented by R.

The proton-conductive composite electrolyte according to the present invention includes an electrolyte having a proton-dissociative group and a compound having a Lewis acid group, is formed by bonding an atom M that constitutes the Lewis acid group MXₙ₋₁ and that accepts an electron to an atom that constitutes the proton-dissociative group, which is an anionic group, and that donates an electron, and is preferably used in a fuel cell.

The compound having a Lewis acid group is, for example, a Lewis acid compound MXₙ or a polymer in which a plurality of Lewis acid groups MXₙ₋₁ are bonded to the main chain or the side chains (in particular, the side chains).

The atom M that constitutes the Lewis acid group MXₙ₋₁ and that accepts an electron is preferably boron (B) or aluminum (Al) from the standpoint of reactivity, and X is preferably a halogen atom.

In addition, the proton-dissociative group is preferably a sulfonic acid group (—SO₃H), which has a high dissociation property of a proton. Alternatively, the proton-dissociative group may be a phosphonic group (—PO(OH)₂), a bis-sulfonimide group (—SO₂NHSO₂—), a sulfonamide group (—SO₂NH₂), a carboxyl group (—COOH), a diphosphonomethano group (═C(PO(OH)₂)₂), or a disulfonomethano group (═C(SO₃H)₂). A plurality of such proton-dissociative groups are preferably introduced into the side chains of a polymer or fullerene.

The electrolyte having a proton-dissociative group is, for example, a fluorine-containing electrolyte, an electrolyte composed of a hydrocarbon-based resin, an inorganic resin, a hybrid resin of an organic resin and an inorganic resin or the like, or a fullerene compound.

A proton-conductive composite electrolyte membrane-catalyst electrode (membrane-electrode assembly, MEA) including a membrane composed of the proton-conductive composite electrolyte according to the present invention and catalyst electrodes provided so as to be in close contact with both sides of this membrane (membrane-shaped electrodes including a catalyst metal carried on an electrically conductive carrier) is preferably used in a fuel cell.

This proton-conductive composite electrolyte includes an electrolyte having a proton-dissociative group and a compound having a Lewis acid group, in which the Lewis acid group and the proton-dissociative group are bonded to each other. Accordingly, proton dissociation is accelerated to improve the proton-conducting property, swelling of the electrolyte with water can be suppressed, and the electrolyte can be insoluble in water. Furthermore, by using, as the electrolyte, a resin having a low methanol permeability and having heat resistance, e.g., sulfonated polyphenoxybenzoyl phenylene (S-PPBP), the methanol permeability is decreased to suppress methanol crossover, and heat resistance can be improved.

By using this proton-conductive composite electrolyte as an electrolyte membrane for a fuel cell, it is possible to realize a fuel cell which has a low cell resistance and in which methanol crossover is suppressed.

Furthermore, when this proton-conductive composite electrolyte is used as an electrolyte in catalyst electrodes for a fuel cell, proton conduction can be performed smoothly, and catalyst electrodes having a stable structure can be realized.

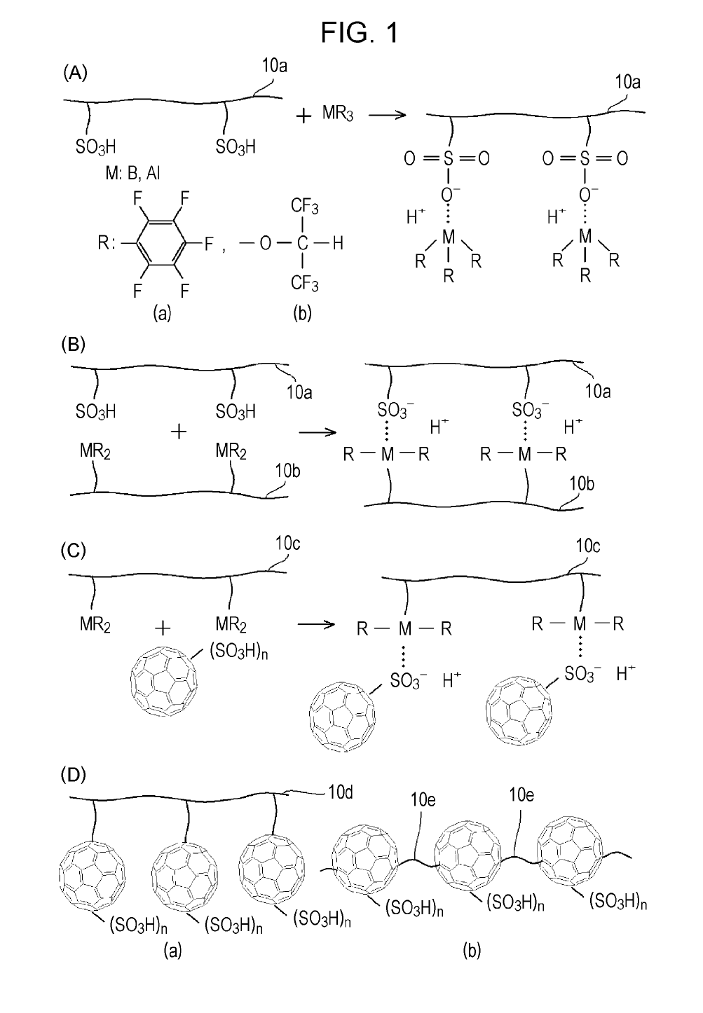

FIG. 1 includes drawings for explaining a proton-conductive composite electrolyte according to an embodiment of the present invention. FIG. 1(A) shows a proton-conductive composite electrolyte formed by an interaction between an electrolyte (polymer) having a plurality of proton-dissociative groups in the side chains thereof and a compound (low-molecular compound) MR₃ having a Lewis acid group. FIG. 1(B) shows a proton-conductive composite electrolyte formed by an interaction between an electrolyte (polymer) having a plurality of proton-dissociative groups in the side chains thereof and a compound (polymer) having a plurality of Lewis acid groups in the side chains thereof. FIG. 1(C) shows a proton-conductive composite electrolyte formed by an interaction between a fullerene compound having at least one proton-dissociative group and a compound (polymer) having a plurality of Lewis acid groups MR₂ in the side chains thereof. FIG. 1(D) shows (a) an electrolyte polymer having a plurality of molecules of a fullerene compound having at least one proton-dissociative group in the side chains thereof, and (b) an electrolyte (polymer) in which a plurality of molecules of a fullerene compound having at least one proton-dissociative group are linked to each other, (a) and (b) being capable of being used instead of the fullerene compound shown in FIG. 1(C).

FIG. 1(A) shows a proton-conductive composite electrolyte formed by an electrolyte composed of a polymer having sulfonic acid groups (—SO₃H) as proton-dissociative groups in the side chains of a polymer backbone 10a and a Lewis acid compound MR₃ having a Lewis acid group.

Note that, in FIG. 1, MR₂ obtained by removing one R from the Lewis acid compound MR₃ is referred to as “Lewis acid group”. Accordingly, the Lewis acid compound MR₃ is a compound having the Lewis acid group MR₂. In addition, the proton-conductive composite electrolyte is a polymer electrolyte having a Lewis acid group, and a membrane (polymer electrolyte membrane) is formed using this polymer electrolyte.

In the example shown in FIG. 1(A), in the Lewis acid compound MR₃, M is aluminum (Al) or boron (B), and R is a (a) pentafluorophenyl group (—C₆F₅) or a (b) hexafluoroisopropoxyl group (—OCH(CF₃)₂).

As shown in FIG. 1(A), by adding the Lewis acid compound to the electrolyte polymer having a plurality of sulfonic acid groups in the side chains thereof, proton dissociation of the sulfonic acid groups is accelerated by an interaction (giving and receiving of electrons) between the sulfonic acid groups of the electrolyte and the Lewis acid compound MR₃, protons are dissociated from the sulfonic acid groups of the side chains of the polymer backbone 10a, a coordination bond is formed between M (electron acceptor), which is a center element of the Lewis acid compound MR₃, and O⁻ (electron donor) of a sulfonic acid group from which a proton has been dissociated, thus forming a proton-conductive composite electrolyte. Accordingly, a proton-conductive composite electrolyte having an excellent proton-conducting property can be obtained. In addition, since the electrolyte is composed of a polymer, an electrolyte that is insolubilized in water is provided.

FIG. 1(B) shows a proton-conductive composite electrolyte formed by an electrolyte composed of a polymer having sulfonic acid groups (—SO₃H) as proton-dissociative groups in the side chains of a polymer backbone 10a, and a compound composed of a polymer having Lewis acid groups MR₂ in the side chains of a polymer backbone 10b. R in each of the Lewis acid groups MR₂ is the same as (a) or (b) shown in FIG. 1(A).

As shown in FIG. 1(B), by adding the polymer having a plurality of Lewis acid groups MR₂ in the side chains thereof to the electrolyte polymer having a plurality of sulfonic acid groups in the side chains thereof, proton dissociation of the sulfonic acid groups is accelerated by an interaction between the sulfonic acid groups of the electrolyte and the Lewis acid groups MR₂, protons are dissociated from the sulfonic acid groups of the side chains of the polymer backbone 10a, and a coordination bond is formed between M (electron acceptor), which is a center element of the Lewis acid group MR₂, and O⁻ (electron donor) of a sulfonic acid group from which a proton has been dissociated, thus forming a proton-conductive composite electrolyte. Accordingly, as in the case of FIG. 1(A), a proton-conductive composite electrolyte having an excellent proton-conducting property can be obtained. In addition, water resistance is further improved by the bonding between the two polymers.

Alternatively, a proton-conductive composite electrolyte having an excellent proton-conducting property can be formed by using a compound that has a proton-dissociative group and that does not form a polymer without using, as an electrolyte, a polymer having proton-dissociative groups in the side chains thereof.

For example, it is possible to use a fullerene compound which is a fullerene derivative including a fullerene molecule (forming a spherical cluster molecule) such as C₃₆, C₆₀, C₇₀, C₇₆ , C₇₈, C₈₀, C₈₂, or C₈₄ as a parent substance and in which a proton-dissociative group such as a sulfonic acid group is bonded to a carbon atom of the parent substance either directly or with a linking chain (linker) therebetween.

FIG. 1(C) shows a proton-conductive composite electrolyte formed by an electrolyte that is composed of a fullerene compound having a sulfonic acid group (—SO₃H)ₙ as a proton-dissociative group and that does not form a polymer and a polymer having a plurality of Lewis acid groups MR₂ in the side chains of a polymer backbone 10c.

It should be noted that, in FIGS. 1(C) and 1(D), the sulfonic acid group “(—SO₃H)ₙ” means that at least one sulfonic acid group (—SO₃H), the number of which is n (n=1 to 12), is bonded to a corresponding carbon atom of the parent substance of the fullerene compound either directly or with a linking chain (linker) therebetween. Instead of the sulfonic acid groups (—SO₃H), other proton-dissociative groups may be bonded to carbon atoms of the parent substance of the fullerene compound (this also applies to the examples described above).

As shown in FIG. 1(C), by adding the polymer having Lewis acid groups MR₂ in the side chains thereof to the electrolyte composed of a fullerene compound having a sulfonic acid group, proton dissociation of the sulfonic acid group is accelerated by an interaction between the sulfonic acid group of the electrolyte and a Lewis acid group MR₂ of the polymer, a proton is dissociated from the sulfonic acid group of a side chain of the fullerene compound, and a coordination bond is formed between M (electron acceptor), which is a center element of the Lewis acid group MR₂, and O⁻ (electron donor) of the sulfonic acid group from which the proton has been dissociated, thus forming a proton-conductive composite electrolyte. Accordingly, as in the cases of FIGS. 1(A) and 1(B), a proton-conductive composite electrolyte having an excellent proton-conducting property can be obtained. Even when the fullerene compound is soluble in water, because of the bonding with the polymer having Lewis acid groups, it is possible to obtain a proton-conductive composite electrolyte that is insolubilized in water.

Instead of the fullerene compound shown in FIG. 1(C), a polymer including a plurality of molecules of the fullerene compound shown in FIG. 1(C) can also be used as an electrolyte, and a proton-conductive composite electrolyte having an excellent proton-conducting property can be obtained as in the cases of FIGS. 1(A), 1(B), and 1(C).

FIG. 1(D) shows an example of an electrolyte composed of a polymer having a plurality of molecules of the fullerene compound shown in FIG. 1(C), and shows (a) an electrolyte composed of a polymer having a plurality of molecules of a fullerene compound having at least one sulfonic acid group (—SO₃H)ₙ in the side chain of a polymer backbone 10d and (b) an electrolyte in which a plurality of molecules of a fullerene compound having at least one sulfonic acid group (—SO₃H)ₙ are linked to each other, with a linking chain 10e therebetween, to form a polymer. Even in the case where the fullerene compound is soluble in water, the electrolytes shown in FIG. 1(D) each composed of a polymer containing a fullerene compound is insoluble in water.

In FIG. 1, a description has been made by taking a sulfonic acid group (—SO₃H) as an example of the proton-dissociative group. However, the proton-dissociative group may be a group selected from those described below.

The proton-dissociative group is a functional group from which a proton can be removed by ionization, and represented by a formula —XH, wherein X is any divalent atom or atomic group. Examples of the proton-dissociative group, which include the above-mentioned groups, include a hydroxyl group —OH, a mercapto group —SH, a carboxyl group —COOH, a sulfonic acid group —SO₂OH, a sulfonamide group —SO₂NH₂, a bis-sulfonimide group —SO₂NHSO₂—, a bis-sulfonimide group —SO₂NHSO₂—, a sulfoncarbonimide group —SO₂NHCO—, a biscarbonimide group —CONHCO—, a phosphonomethano group ═CH(PO(OH)₂), a diphosphonomethano group ═C(PO(OH)₂)₂, a disulfonomethano group (═C(SO₃H)₂), a phosphonomethyl group —CH₂(PO(OH)₂), a diphosphonomethyl group —CH(PO(OH)₂)₂, a sulfino group —SO(OH), a sulfeno group —S(OH), a sulfate group —OSO₂OH, a phosphonic acid group —PO(OH)₂, a phosphine group —HPO(OH), a phosphate group —O—PO(OH)₂ and —OPO(OH)O—, a phosphonyl group —HPO, and a phosphinyl group —H₂PO. The proton-dissociative group may be a derivative obtained by substituting any of these proton-dissociative groups with a substituent.

Various electrolytes can be used as the electrolyte having a proton-dissociative group. For example, an organic resin (organic polymer) can be used.

Publicly known electrolytes having a proton-conducting property, such as a fluorine-containing electrolyte membrane, a hydrocarbon-based electrolyte membrane, polytetrafluoroethylene (PTFE), and polyvinylidene fluoride (PVDF) can be used, and an electrolyte membrane can be formed by using any of these electrolytes.

As a fluorine-containing electrolyte having a proton-dissociative group, it is possible to use publicly known fluorine-containing electrolytes composed of, for example, a resin containing, as a base polymer, a perfluorocarbon sulfonic acid-based polymer, a polytrifluorostyrene sulfonic acid-based polymer, a perfluorocarbon phosphonic acid-based polymer, a trifluorostyrene sulfonic acid-based polymer, an ethylene tetrafluoroethylene-g-styrene sulfonic acid-based polymer, an ethylene-tetrafluoroethylene copolymer, a polyvinylidene fluoride-perfluorocarbon sulfonic acid-based polymer, an ethylene-ethylene tetrafluoride copolymer, or trifluorostyrene.

As a hydrocarbon-based resin having a proton-dissociative group, it is possible to use publicly known hydrocarbon-based electrolyte composed of, for example, sulfonated polyethersulfone (S-PES), polybenzimidazole (PBI), polybenzoxazole (PBO), sulfonated polyphenoxybenzoyl phenylene (S-PPBP), sulfonated polyether ether ketone (S-PEEK), sulfonamide polyethersulfone, sulfonamide polyether ether ketone, sulfonated cross-linked polystyrene, sulfonamide cross-linked polystyrene, sulfonated polytrifluorostyrene, sulfonamide polytrifluorostyrene, sulfonated polyaryl ether ketone, sulfonamide polyaryl ether ketone, sulfonated poly(aryl ether sulfone), sulfonamide poly(aryl ether sulfone), polyimide, sulfonated polyimide, sulfonamide polyimide, sulfonated 4-phenoxybenzoyl-1,4-phenylene, sulfonamide 4-phenoxybenzoyl-1,4-phenylene, phosphonated 4-phenoxybenzoyl-1,4-phenylene, sulfonated polybenzimidazole, sulfonamide polybenzimidazole, phosphonated polybenzimidazole, sulfonated polyphenylene sulfide, sulfonamide polyphenylene sulfide, sulfonated polybiphenylene sulfide, sulfonamide polybiphenylene sulfide, sulfonated polyphenylene sulfone, sulfonamide polyphenylene sulfone, sulfonated polyphenoxybenzoyl phenylene, sulfonated polystyrene-ethylene-propylene, sulfonated polyphenylene imide, polybenzimidazole-alkyl sulfonic acid, or sulfoallylated polybenzimidazole.

In addition, an electrolyte composed of a hybrid polymer of an inorganic resin and an organic resin such as a hydrocarbon-based resin or a fluorine-containing electrolyte can also be used. In this case, the organic resin and/or the inorganic resin has a proton-dissociative group. For example, as the inorganic resin, an organic silicon polymer having a Si-0 bond in the main backbone can be used, and a polysiloxane compound having a group substituted with sulfonic acid in the side chain thereof can be used.

Next, a description will be made of examples of the Lewis acid and examples of the functional group (Lewis acid group) acting as a Lewis acid, the Lewis acid and the Lewis acid group being capable of being used for forming the proton-conductive composite electrolytes shown in FIG. 1.

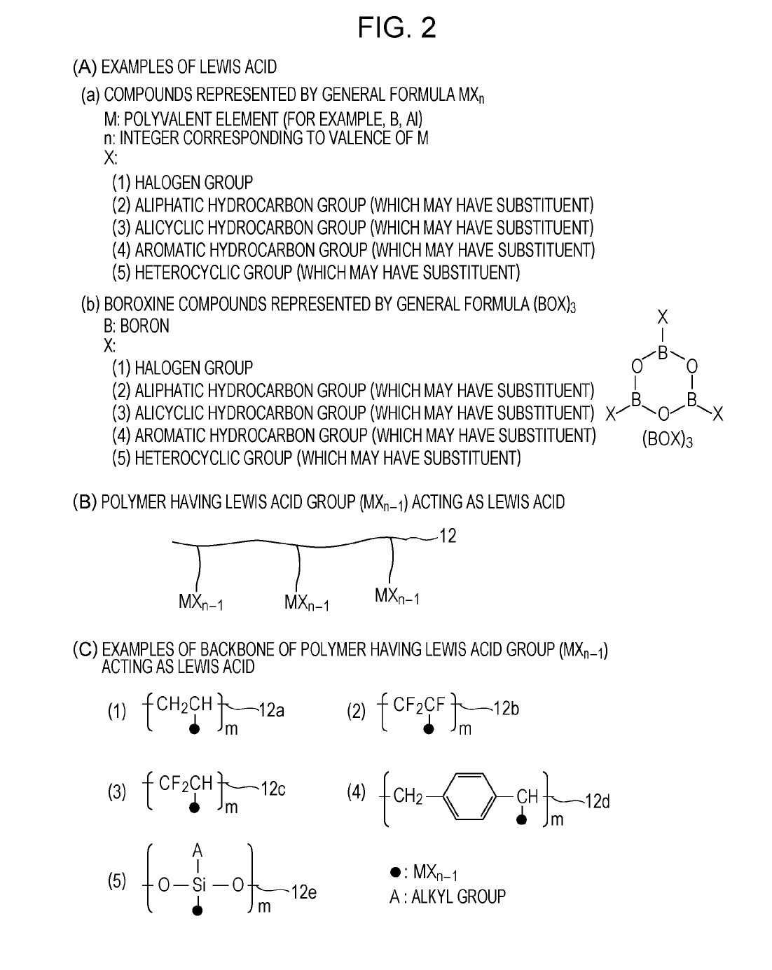

FIG. 2 includes drawings for explaining examples of the Lewis acid and examples of the functional group (Lewis acid group) acting as a Lewis acid.

FIG. 2(A) shows, as examples of the Lewis acid, examples of (a) compounds represented by a general formula MXₙ, and (b) compounds represented by a general formula (BOX)₃. FIG. 2(B) schematically shows an electrolyte composed of a polymer having Lewis acid groups (functional groups) MXₙ₋₁ in the side chains of a polymer backbone 12. FIG. 2(C) shows polymer backbones having Lewis acid groups (functional groups) MXₙ₋₁ in the side chains of polymer backbones 12a to 12e.

The Lewis acid compounds shown in (a) of FIG. 2(A) and represented by the general formula MXₙ (n 3) are inorganic or organic compounds. M is a polyvalent element which is a center atom of the Lewis acid MXₙ, and n is preferably 3, 4, or 5. M is an element of, for example, Al, B, Ti, Zr, Sn, Zn, Ga, Bi, Sb, Si, Cd, V, Mo, W, Mn, Fe, Cu, Co, Pb, Ni, Ag, Ce, or a lanthanoid element (such as Sc, Yb, or La).

Xs are each an anionic group constituting the Lewis acid MXₙ, and are one or two types of groups selected from (1) halogen groups, (2) aliphatic hydrocarbon groups, (3) alicyclic hydrocarbon groups, (4) aromatic hydrocarbon groups, and (5) heterocyclic groups. All Xs, the number of which is n, may be different from each other or some of or all of Xs may be the same. In addition, among Xs, the number of which is n, two of Xs may be bonded to each other to form a ring, and furthermore, this group may have a substituent.

Here, each of the aliphatic hydrocarbon groups is a monovalent group that is a residue obtained by removing one hydrogen atom (H) from an aliphatic hydrocarbon compound, and each of the aliphatic hydrocarbon groups may be substituted with any substituent.

In addition, each of the alicyclic hydrocarbon groups is a monovalent group that is a residue obtained by removing one hydrogen atom (H) from an alicyclic hydrocarbon compound, and the each of the alicyclic hydrocarbon groups may be substituted with any substituent.

In addition, each of the aromatic hydrocarbon groups is a monovalent group that is a residue obtained by removing one hydrogen atom (H) from an aromatic hydrocarbon compound, and each of the aromatic hydrocarbon groups may be substituted with any substituent.

In addition, each of the heterocyclic groups is a monovalent group that is a residue obtained by removing one hydrogen atom (H) from a heterocyclic compound, and each of the heterocyclic groups may be substituted with any substituent.

Examples of a halogen compound represented by the general formula MXₙ include a boron halide represented by BX₃, an aluminum halide represented by AlX₃, a phosphorus halide represented by PX₅, a silicon halide represented by SiX₄, a tin halide represented by SnX₄, fluorides such as AsF₅, VF₅, and SbF₅, and other compounds such as FeCl₃, TiCl₄, MoCl₅, and WCl₅.

Examples of the organic group X in the organic compound represented by the general formula MXₙ include various organic acid groups such as a sulfonic acid group and a phosphate group and various organic groups. Each of the organic groups may be substituted with any substituent.

Examples of the organic group include alkyl groups (such as a methyl group, an ethyl group, a propyl group, and a dodecyl group), cycloalkyl groups (such as a cyclopropyl group and a cyclohexyl group), alkoxy groups (such as a methoxy group and an ethoxy group), alkenyl groups (such as a vinyl group, an allyl group, and a cyclohexenyl group), alkynyl groups (such as an ethynyl group, a 2-propenyl group, and a hexadecynyl group), aralkyl groups (such as a benzyl group, a diphenylmethyl group, and a naphthylmethyl group), aryl groups (such as a phenyl group, a naphthyl group, and an anthryl group), halogen group (a chlorine group, a bromine group, a fluorine group, and an iodine group), aryloxy groups (such as a phenoxy group), alkylthio groups (such as a methylthio group), arylthio groups (such as a phenylthio group), acyloxy groups (such as an acetoxy group), an amino group, a cyano group, a nitro group, a hydroxy group, a formyl group, alkylamino groups (such as a methylamino group and a butylamino group), arylamino groups (such as a phenylamino group), carbonamide groups (such as an acetylamino group and a propanoylamino group), sulfonamide groups (such as a methanesulfonamide group and a benzenesulfonamide group), acyl groups (such as an acetyl group, a benzoyl group, and a pivaloyl group), sulfonyl groups (such as a methanesulfonyl group and a benzenesulfonyl group), sulfinyl groups (such as a methanesulfinyl group), a carboxylic acid group, a sulfonic acid group, a phosphonic acid group, a triflate group (a trifluoromethanesulfonate group, a CF₃SO₃ group), and heterocyclic groups. Examples of the heterocyclic groups include a pyrrole group, an indole group, a furan group, a thiophene group, an imidazole group, a thiazole group, a pyridine group, a pyran group, a thiopyran group, an oxodiazole group, and a thiadiazole group.

More specifically, examples of the organic compound include aluminum alkoxides such as aluminum triethoxide, aluminum triisopropoxide, aluminum tri-s-butoxide, and aluminum tri-t-butoxide; boron alkoxides such as trimethoxyborane and tris(phenoxy)borane; scandium alkoxides such as scandium triisopropoxide; titanium alkoxides such as titanium tetramethoxide, titanium tetraethoxide, titanium tetraisopropoxide, titanium tetra-n-butoxide, titanium tetra-t-butoxide, and titanium tetraphenoxide; zirconium alkoxides such as zirconium tetraisopropoxide; tin alkoxides such as tin tetraisopropoxide; and metal triflates such as ytterbium triflate.

The boroxine compound shown in (b) of FIG. 2(A) and represented by the general formula (BOX)₃ is a Lewis acid compound in which substituents X are bonded to boron atoms B of a six-membered ring including boron atoms B and oxygen atoms O alternately bonded to each other. Similarly to (a) of FIG. 2(A), Xs are one or two types of groups selected from halogen groups, aliphatic hydrocarbon groups, alicyclic hydrocarbon groups, aromatic hydrocarbon groups, heterocyclic groups, and the like. Each of Xs may be substituted with a substituent. Furthermore, three Xs in the boroxine compound may be generally different from each other, or two or three Xs of the three Xs may be the same.

The group X in the boroxine compound represented by the general formula (BOX)₃ is, for example, an alkyl group, a halogen group such as a fluorine group, a cyano group, a nitro group, an acyl group, a sulfonyl group, an alkoxy group, an aryloxy group, an alkyl group substituted with fluorine atoms, such as a trifluoromethyl group, an aryl group substituted with fluorine atoms, a heterocyclic group, or the like.

More specifically, examples of the boroxine compound include trimethylboroxine, 2,4,6-triethylboroxine, tributylboroxine, 2,4,6-tri-tert-butylboroxine, 2,4,6-tricyclohexylboroxine, trimethoxyboroxine, 2,4,6-triphenylboroxine, and 2,4,6-tris[3-(trifluoromethyl)phenyl]boroxine.

The polymer shown in FIG. 2(B) and having Lewis acid groups each represented by a general formula MXₙ₋₁ in the side chains thereof, the Lewis acid groups each being obtained by removing one X from a Lewis acid compound represented by the general formula MXₙ, acts as a Lewis acid. The Lewis acid groups MXₙ₋₁ are each bonded to a polymer chain either directly or with a sulfonic acid (SOA group or a sulfate (SO₄) group therebetween. Alternatively, the Lewis acid groups are each bonded to either a side chain of a polymer chain or a molecular chain for linking, the molecular chain being bonded as a side chain of a polymer chain. The polymer chain and the molecular chain for linking are hydrophobic and are not easily hydrolyzed. The molecular chain for linking may include a hydrocarbon group, specifically, a hydrocarbon group (which may have a substituent) including a cycloalkyl group, an aryl group, or the like. Note that the group X corresponds to the group R in FIGS. 1(B) and 1(C).

The polymer shown in FIG. 2(B) and having the Lewis acid groups MXₙ₋₁ in the side chains of the polymer backbone 12 is prepared by, for example, allowing a polymer to react with chlorosulfonic acid to introduce a sulfonic acid group into a side chain, and by allowing a Lewis acid compound MXₙ to react with this sulfonic acid group to introduce a Lewis acid group MXₙ₋₁ into the side chain.

The Lewis acid group MXₙ₋₁ is a group MXₙ₋₁ obtained by removing one group X from a Lewis acid compound represented by MXₙ (n≧3) described in (a) of FIG. 2(A). Therefore, a description of specific examples thereof is not repeated.

The Lewis acid group MXₙ₋₁ can be linked to a side chain of various polymer backbones. As described above, the polymer chain to which the Lewis acid group MXₙ₋₁ is bonded is a hydrophobic polymer that is not easily dissolved in water or aqueous media, and is a publicly known polymer such as a fluorine-containing polymer, a hydrocarbon-based polymer, or a hybrid polymer (a hybrid product of an organic polymer such as a hydrocarbon-based polymer or a fluorine-containing polymer and an inorganic polymer such as a siloxane-based polymer).

Examples of the backbone of the polymer chain to which a Lewis acid group is bonded include, as shown in FIG. 2(C), (1) a polymer backbone in which a hydrogen atom (H) of polyethylene (PE) is substituted with a Lewis acid group, (2) a polymer backbone in which a fluorine atom (F) of polytetrafluoroethylene (PTFE) is substituted with a Lewis acid group, (3) a polymer in which a hydrogen atom (H) of polyvinylidene fluoride (PVDF) is substituted with a Lewis acid group, (4) a polymer backbone in which a hydrogen atom (H) of poly-p-xylene is substituted with a Lewis acid group, and (5) a polymer backbone in which an alkyl group (A) of an alkyl polysiloxane is substituted with a Lewis acid group. The polymer backbone may be a backbone of an addition polymer of styrene, α-methylene, divinylbenzene, or the like, or a backbone of other various types of polymers.

It should be noted that m shown in FIG. 2(C) represents the number of repetitions (degree of polymerization) of a unit structure (repeating unit of the polymer backbone) in the parentheses [ ] preceding m, and m is 2 to 100,000. Also, the number of Lewis acid groups MX₂ in the polymer having the Lewis acid groups MX₂ in the side chains thereof is 2 to 100,000.

A polymer having, as a polymer backbone, the backbone of a styrene polymer (polystyrene) ((—(C₆H₅)CH—CH₂—)ₘ) and having a structure in which —H of a phenyl group (—C₆H₅) of this polystyrene backbone is substituted with a Lewis acid group —B(C₆F₅)₂ can be synthesized as follows. For example, a polymerization initiator (1-phenylethyl bromide) and a catalyst (copper bromide (CuBr)/pentamethyldiethylenetriamine) are added to 4-trimethylsilylstyrene ((CH₃)₃Si—C₆H₄—CH═CH₂), and radical polymerization is conducted in anisole (C₆H₅OCH₃) at 110° C. to prepare a polymer having a structure in which —H of a phenyl group (—C₆H₅) of the polystyrene backbone is substituted with —Si(CH₃)₃. Next, —Si(CH₃)₃ of this polymer is substituted with a Lewis acid group —BBr₂ in dichloromethane (CH₂Cl₂) using boron tribromide (BBr₃). The polymer substituted with the Lewis acid group —BBr₂ and pentafluorophenylcopper (Cu(C₆F₅)) are allowed to react with each other in dichloromethane (CH₂Cl₂). Thus, a target polymer having a structure in which —H of the phenyl group (—C₆H₅) of the polystyrene backbone is substituted with a Lewis acid group —B(C₆F₅)₂. This polymer is equivalent to a polymer in which —H of a polyethylene backbone ((CH₂—CH₂—)ₘ) is substituted with a group —(C₆H₄)B(C₆F₅)₂.

Next, a description will be made of an example of a fuel cell to which a proton-conductive composite electrolyte having a Lewis acid group is applied.

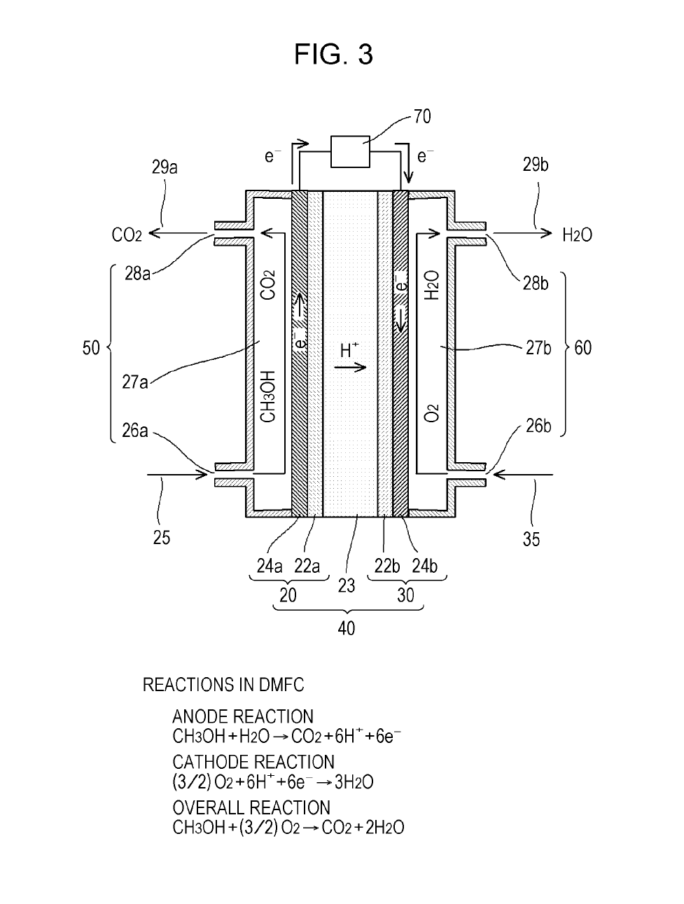

FIG. 3 is a cross-sectional view showing an example of a direct-type methanol fuel cell (DMFC) to which a proton-conductive composite electrolyte having a Lewis acid group is applied, according to an embodiment of the present invention.

As shown in FIG. 3, an aqueous methanol solution is allowed to flow as a fuel 25 from an inlet 26a of a fuel supply portion (separator) 50 having a flow path to a passage 27a. The fuel 25 passes through an electrically conductive gas diffusion layer 24a which is a base and reaches a catalyst electrode 22a that is held by the gas diffusion layer 24a. Methanol and water react to each other on the catalyst electrode 22a in accordance with the anode reaction shown in the lower part of FIG. 3 to produce hydrogen ions, electrons, and carbon dioxide. An exhaust gas 29a containing carbon dioxide is discharged from an outlet 28a. The produced hydrogen ions pass through a polymer electrolyte membrane 23 composed of the above-described proton-conductive composite electrolyte having a Lewis acid group, and reach a catalyst electrode 22b that is held by an electrically conductive gas diffusion layer 24b which is a base. The produced electrons pass through the gas diffusion layer 24a and an external circuit 70, further pass through the gas diffusion layer 24b, and reach the catalyst electrode 22b.

As shown in FIG. 3, air or oxygen 35 is allowed to flow from an inlet 26b of an air or oxygen supply portion (separator) 60 having a flow path to a passage 27b. The air or oxygen 35 passes through the gas diffusion layer 24b and reaches the catalyst electrode 22a that is held by the gas diffusion layer 24b. Hydrogen ions, electrons, and oxygen react to each other on the catalyst electrode 22b in accordance with the cathode reaction shown in the lower part of FIG. 3 to produce water. An exhaust gas 29b containing water is discharged from an outlet 28b. As shown in the lower part of FIG. 3, the overall reaction is a combustion reaction of methanol in which electrical energy is taken from methanol and oxygen, and water and carbon dioxide are discharged.

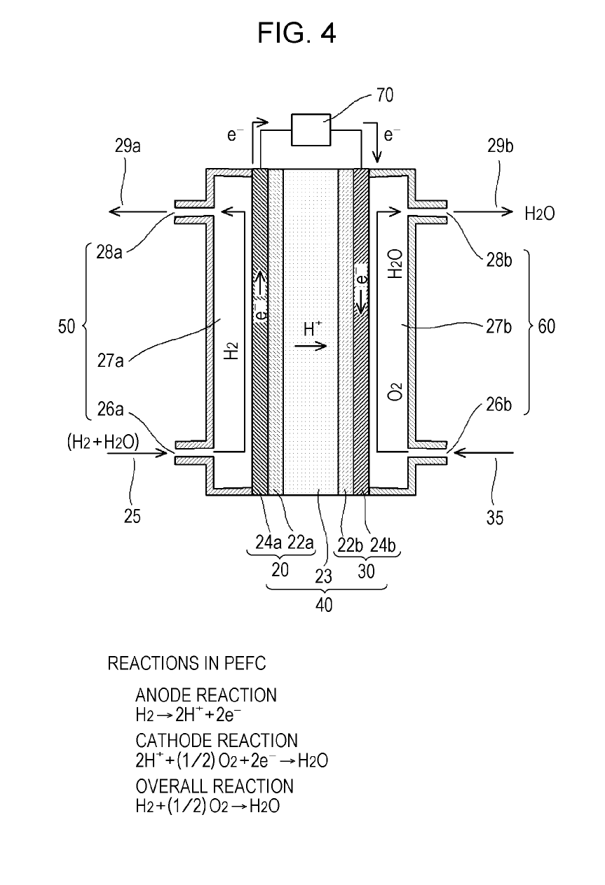

FIG. 4 is a cross-sectional view showing an example of a polymer electrolyte-type fuel cell (PEFC) to which a proton-conductive composite electrolyte having a Lewis acid group is applied, according to an embodiment of the present invention.

As shown in FIG. 4, a humidified hydrogen gas is allowed to flow as a fuel 25 from an inlet 26a of a fuel supply portion 50 to a passage 27a. The fuel 25 passes through a gas diffusion layer 24a and reaches a catalyst electrode 22a. Hydrogen ions and electrons are produced from the hydrogen gas on the catalyst electrode 22a in accordance with the anode reaction shown in the lower part of FIG. 4. An exhaust gas 29a containing excess hydrogen gas is discharged from an outlet 28a. The produced hydrogen ions pass through a polymer electrolyte membrane 23 composed of the above-described proton-conductive composite electrolyte having a Lewis acid group, and reach a catalyst electrode 22b. The produced electrons pass through the gas diffusion layer 24a and an external circuit 70, further pass through a gas diffusion layer 24b, and reach the catalyst electrode 22b.

As shown in FIG. 4, air or oxygen 35 is allowed to flow from an inlet 26b of an air or oxygen supply portion 60 to a passage 27b. The air or oxygen 35 passes through the gas diffusion layer 24b and reaches the catalyst electrode 22a. Hydrogen ions, electrons, and oxygen react to each other on the catalyst electrode 22b in accordance with the cathode reaction shown in the lower part of FIG. 4 to produce water. An exhaust gas 29b containing water is discharged from an outlet 28b. As shown in the lower part of FIG. 4, the overall reaction is a combustion reaction of hydrogen gas in which electrical energy is taken from hydrogen gas and oxygen, and water is discharged.

In FIGS. 3 and 4, the polymer electrolyte membrane 23 is formed by binding the proton-conductive composite electrolyte with a binder (e.g., polytetrafluoroethylene (PTFE), polyvinylidene fluoride (PVDF), or the like). An anode 20 and a cathode 30 are separated by the polymer electrolyte membrane 23, and hydrogen ions and water molecules move through the polymer electrolyte membrane 23. Preferably, the polymer electrolyte membrane 23 is a membrane having a high conducting property of hydrogen ions, is chemically stable, and has a high mechanical strength.

In FIGS. 3 and 4, the catalyst electrodes 22a and 22b are formed so as to be in close contact with the gas diffusion layers 24a and 24b, respectively, which constitute electrically conductive bases serving as current collectors and which have permeability to gases and solutions. The gas diffusion layers 24a and 24b are each composed of a porous base such as carbon paper, a formed body of carbon, a sintered body of carbon, a sintered metal, or a foam metal. In order to prevent a decrease in the gas diffusion efficiency due to water produced by the driving of the fuel cell, the gas diffusion layers are subjected to a water-repellent treatment with a fluorocarbon resin or the like.

The catalyst electrodes 22a and 22b are each formed by, for example, binding a carrier carrying a catalyst composed of platinum, ruthenium, osmium, a platinum-osmium alloy, a platinum-palladium alloy, or the like with a binder (e.g., polytetrafluoroethylene, polyvinylidene fluoride (PVDF), or the like). As the carrier, for example, inorganic fine particles of carbon such as acetylene black or graphite, alumina, or silica are used. A solution prepared by dispersing carbon particles (on which a catalyst metal is carried) in an organic solvent in which a binder is dissolved is applied onto the gas diffusion layers 24a and 24b, and the organic solvent is evaporated, thereby forming the membrane-shaped catalyst electrodes 22a and 22b, respectively, which are bound with the binder.

The polymer electrolyte membrane 23 is sandwiched between the catalyst electrodes 22a and 22b formed so as to be in close contact with the gas diffusion layers 24a and 24b, respectively, to form a membrane-electrode assembly (MEA) 40. The catalyst electrode 22a and the gas diffusion layer 24a constitute the anode 20, and the catalyst electrode 22b and the gas diffusion layer 24b constitute the cathode 30. The anode 20 and the cathode 30 are in close contact with the polymer electrolyte membrane 23. The catalyst electrodes 22a and 22 and the polymer electrolyte membrane 23 are assembled so as to be in close contact with each other in a state in which the proton conductor enters between the carbon particles, and the polymer electrolyte (proton conductor) is impregnated into the catalyst electrodes 22a and 22b. Thus, a high conducting property of hydrogen ions is maintained at the assembled interface, and the electrical resistance is maintained to be low. Note that the catalyst electrodes may contain the above-described proton-conductive composite electrolyte having a Lewis acid group. In such a case, proton conduction at the assembled interface is performed smoothly.

Incidentally, in the examples shown in FIGS. 3 and 4, each of the openings of the inlet 26a of the fuel 25, the outlet 28a of the exhaust gas 29a, the inlet 26b of air or oxygen (O₂) 35, and the outlet 28b of the exhaust gas 29b is disposed perpendicular to the surfaces of the polymer electrolyte membrane 23 and the catalyst electrodes 22a and 22b. However, each of the openings may be disposed in parallel with the surfaces of the polymer electrolyte membrane 23 and the catalyst electrodes 22a and 22b. Thus, various modifications can be made regarding the arrangement of the respective openings.

The fuel cells shown in FIGS. 3 and 4 can be produced by using general methods disclosed in various documents, and thus a detailed description regarding the production is omitted.

The present invention has been described by way of embodiments. However, the present invention in not limited to the embodiments described above, and various modifications can be made on the basis of the technical idea of the present invention.

### INDUSTRIAL APPLICABILITY

The present invention can be preferably used in a power-generating device, such as a fuel cell, based on an electrochemical reaction.

### Reference Signs List

10a to 10d, 12a to 12e: polymer backbone, 10e: linking chain, 20: anode, 22a and 22b: catalyst electrode, 23: polymer electrolyte membrane, 24a and 24b: gas diffusion layer, 25: fuel, 27a and 27b: passage, 28a and 28b: outlet, 29a and 29b: exhaust gas, 30: cathode, 35: air or oxygen, 40: membrane-electrode assembly, 50: fuel supply portion, 60: air or oxygen supply portion

1-9. (canceled)

10. A proton-conductive composite electrolyte comprising:
an electrolyte having a proton-dissociative group; and
a compound having a Lewis acid group, wherein an electron-accepting atom constituting the Lewis acid group and an electron-donating atom constituting the proton-dissociative group are bonded to each other.

11. The proton-conductive composite electrolyte according to claim 10, wherein the compound is a polymer having a plurality of the Lewis acid groups in side chains thereof.

12. The proton-conductive composite electrolyte according to claim 10, wherein the proton-dissociative group is at least one selected from the group consisting of a sulfonic acid group (—SO₃H), a phosphonic group (—PO(OH)₂), a bis-sulfonimide group (—SO₂NHSO₂—), a sulfonamide group (—SO₂NH₂), a carboxyl group (—COOH), a diphosphonomethano group (═C(PO(OH)₂)₂), and a disulfonomethano group (═C(SO₃H)₂).

13. The proton-conductive composite electrolyte according to claim 10, wherein the electron-accepting atom constituting the Lewis acid group is boron (B) or aluminum (Al).

14. The proton-conductive composite electrolyte according to claim 13, wherein the electrolyte is at least one selected from the group consisting of a fullerene compound having the proton-dissociative group, a polymer having, in side chains thereof, a plurality of molecules of a fullerene compound having the proton-dissociative group, a polymer in which a plurality of molecules of a fullerene compound having the proton-dissociative group are linked to each other, and a polymer having a plurality of the proton-dissociative groups in the side chains thereof

15. A membrane-electrode assembly comprising an electrolyte membrane composed of the proton-conductive composite electrolyte according to claim 10, and catalyst electrodes in which a catalyst metal is carried on an electrically conductive carrier, wherein the catalyst electrodes are disposed on both sides of the electrolyte membrane.

16. The membrane-electrode assembly according to claim 16, wherein the catalyst electrodes contain the proton-conductive composite electrolyte.

17. An electrochemical device comprising the membrane-electrode assembly according to claim 15, wherein the electrochemical device is configured so that a proton generated in one of the pair of catalyst electrodes disposed on both sides of the electrolyte membrane is moved to the other catalyst electrode by the electrolyte membrane.

18. The electrochemical device according to claim 18, wherein the electrochemical device is formed as a fuel cell.
